(19) United States
(12) Patent Application Publication
(10) Pub. No.: US 2004/0035447 A1
(43) Pub. Date: Feb. 26, 2004

(54) Method and apparatus for manipulating a spray bar

(76) Inventor: Keith M. Schleeter, Bloomington, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/386,382

(22) Filed: Mar. 10, 2003

Related U.S. Application Data
(60) Provisional application No. 60/362,909, filed on Mar. 8, 2002.

(51) Int. Cl. B08B 1/02

(52) U.S. Cl. 134/32; 134/36; 134/123; 134/165; 134/198

(57) ABSTRACT

A vehicle washing apparatus and method utilizes an arch shaped support structure spanning the width of a washing area in which the vehicle is positioned. The arch shaped support structure comprises a rigid frame assembly with a pair of vertical support columns that move on a track along the sides of the vehicle. Attached to the support structure is a spray bar assembly and drive system. The spray bar assembly of preferred embodiments of the present invention has a first end and second end and is attached to the arch support structure at said ends by way of a first connecting member and a second connecting member respectively which are preferably configured as roller assemblies which engage guide. Also attached to the ends of the spray bar assembly are cables, lines, chains or the like connecting to a pair of counterweights that counter the weight of the spray bar assembly and facilitate easy movement of same within the support structure. A force equalization circuit comprising lines and pulleys, preferably configured as a loop whereby downward motion of the first end of the spray bar assembly also effectuates a simultaneous downward pulling of the second end of the spray bar assembly. Similarly an upward motion of the first end of the spray bar assembly also effectuates a simultaneous upward pulling of the second end of the spray bar assembly. This eliminates the potential for binding of the spray bar assembly in the support structure, as well as minimizing stress and wear on components, as well as providing a highly responsive washing action.

This application claims priority to Provisional Application No. 60/362,909 filed Mar. 8, 2002, which is incorporated herein by reference.

The present invention relates generally to the field of motor vehicle washing. More specifically, the present invention relates to a method and apparatus for an automated car washing system utilizing a spray bar in conjunction with a positioning apparatus.

### BACKGROUND OF THE INVENTION

A variety of methods have been employed for cleaning motor vehicles in automated car washes. In situations where there is no space limitation, proprietors may choose to install tunnel style washers in which a dirty car enters one end, is subjected to a series of cleaning, rinsing and drying steps and finally emerges in a clean state at the opposite end.

An example of such a tunnel system includes U.S. Pat. No. 3,793,667 to Capra. Capra discloses a dual rotary brush system mounted and operating off a frame that encompasses the vehicle path. As vehicles travel the tunnel length, they come into contact with the dual brush system which subsequently removes dirt and grime present on the vehicle.

Another example of a tunnel style wash system is U.S. Pat. No. 5,924,156 to Belanger et al. Belanger discloses a stationary washing system encompassing a vehicle's path in which cloth strips oscillate back and forth across a vehicle. This scrubbing motion serves to remove any dirt and grime present on the vehicle.

Another design has been implemented when the car wash must be installed within specified space limitations. These limitations may be due to costs associated with acquiring and developing new space or because existing space is being used and renovated to accommodate an automated washer. In these instances, the preferred method is to install a system wherein a vehicle is driven into the space, remains stationary during the cleaning process and exits the space once the cleaning process is complete. While there are a number of designs that fit this criteria, they all share the characteristic of the wash system moving while the vehicle remains stationary.

One example of a moving car wash system is U.S. Pat. No. 4,453,284 to Shleeter. The '284 patent discloses a combination of brushes and cloth strips mounted to a mobile frame structure. The movement of the frame structure in relation to the vehicle is accomplished through a track system that the frame structure rides on. Other variations on this track based system include U.S. Pat. No. 5,339,478 to Schleeter and U.S. Pat. No. 5,577,288 to Stinnett et al.

Over time, operators of automated car washers became concerned that the scrubbing mechanism provided by brushes and cloth strips was not enough to remove materials such as tar, oil other materials from the roadside. Ultimately operators began to look at new touchless implements to overcome these limitations. These implements manifested themselves in the forms of spray nozzles capable of cleaning the exterior surface through a combination of high pressure and appropriate cleaning chemicals.

An example of such a touchless design is demonstrated by U.S. Pat. No. 5,161,557 to Scheiter. Scheiter discloses a track mounted wash system utilizing a support arch. Spray jets are oriented on a gantry which traverses the support arch so that the jets spray the vehicle from above and from both sides.

While car wash technology as increased, there remains opportunities for improvement in the areas of contaminant removal, system flexibility and ease of construction and maintenance.

### SUMMARY OF THE INVENTION

A preferred embodiment of a vehicle washing apparatus has a spray arch rollably mounted on a track and a spray bar assembly and drive system that offers advantages in construction, maintenance, efficiency, performance and overall safety. In addition, the spray bar of the present invention allows the proprietor or consumer the potential to quickly and easily select the wash thoroughness required due to site peculiarities including geographical location, climate conditions and an individual's vehicle.

A preferred embodiment of a car wash design utilizing the spray bar assembly and drive system of the present invention has an arch shaped support structure spanning the width of a washing area in which the vehicle is positioned. The arch shaped support structure comprises a rigid frame assembly with a pair of vertical support columns that move along the side of the vehicle. The support structure may have an exterior sheet metal skin to enclose plumbing, mechanical, and structural components and to provide an aesthetically pleasing appearance. Located at the base of each side of the spray arch are wheels allowing the spray arch to travel forward and back along a track formed of parallel rails over the length of the vehicle being washed.

The spray bar assembly of preferred embodiments of the present invention has a first end and second end and is attached to the arch support structure at said ends by way of a first connecting member and a second connecting member respectively which are preferably configured as roller assemblies which engage guide surfaces and ride within vertical channels located in the arch support structure. Also attached to the ends of the spray bar assembly are cables, lines, chains or the like connecting to a pair of counterweights that counter the weight of the spray bar assembly and facilitate easy movement of same within the support structure.

Attached to the first connecting member and second connecting member is a circuit comprising a line such as a cable, chain or the like, that extend through a series of pulleys. Such a circuit is preferably a loop whereby downward motion of the first end of the spray bar assembly also effectuates a simultaneous downward pulling of the second end of the spray bar assembly. Similarly an upward motion of the first end of the spray bar assembly also effectuates a simultaneous upward pulling of the second end of the spray bar assembly. This eliminates the potential for binding of the spray bar assembly in the support structure as well as minimizing stress and wear on components.

In preferred embodiments, the spray bar assembly is driven upwardly and downwardly in response to force applied by the air cylinder. A control system of the automated car wash will provide control signals to the air cylinder as well as all other fluid control features and to drive the arch shaped support structure along the track. Through the use of the first counterweight and second counterweight, the speed and responsiveness of the spray bar travels is dramatically increased. In order to limit the travel path of the spray bar, a series of limit switches may be included that work in conjunction with the control system. In addition to the vertical movement of the spray bar assembly, a spray bar portion is rotatably mounted to the spray bar assembly so that the spray bar can rotate forward and back allowing the spray to come from any desired angle as controlled by the control system. A drive motor operated pneumatically, hydraulically, or electrically controls the rotational positioning of the spray bar.

An advantage of the spray bar of the present invention is that the capability for rapid vertical motion allows a proprietor or user to easily select the level of washing that the vehicle requires. The proprietor or user could alter the washing sequence due to specific climatological, environmental conditions, or the condition of the vehicle. For example, in a situation where the car has accumulated significant amounts of dirt and grime, the user could increase the number of vertical passes by the spray bar.

Another advantage of the spray bar of the present invention is that the vertical motion of the spray bar could be easily combined with proximity sensors or other control programming that would allow the spray bar to follow the contours of the vehicle as the spray arch travels back and forth over the stationary vehicle. By keeping the spray bar in close proximity to the vehicle at all times, the vehicle would see a stream of water with consistent pressure and volume. This would provide for even cleaning across the length of the vehicle.

### BRIEF DESCRIPTION OF THE DRAWINGS

FIG. 1 is a perspective view of a touchless car wash system including a spray bar as described by the present invention.

FIG. 2 is a schematic front elevational view of the sprayer arch on the track.

FIG. 3 is a front perspective view of the sprayer arch on the track.

FIG. 4 is a side perspective view of the sprayer arch with pertinent portions exposed.

FIG. 5 is an elevational view of one side of the sprayer arch and rail.

FIG. 6 is an elevational view of the other side of the sprayer arch and rail.

### DETAILED DESCRIPTION OF THE DRAWINGS

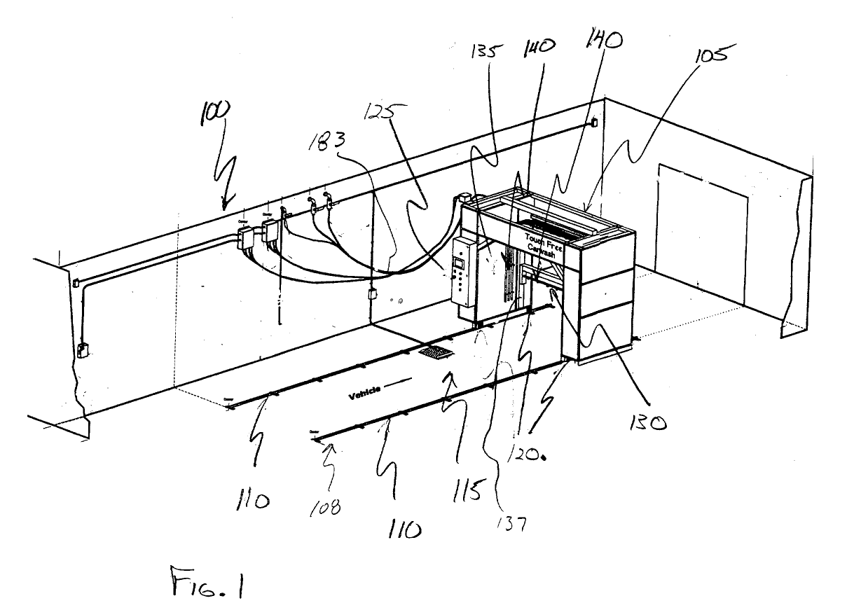

FIG. 1 contains a view of vehicle wash 100. Sprayer arch 105 is mounted on a track 108 comprised of a pair of rails 110. As sprayer arch 105 moves along track 108 and defines a vehicle wash zone 115. Sprayer arch 105 is engaged with the rails 110 through wheels 120. Vehicle wash 100 is configured as a “touchless” wash and operates via control system 125. Sprayer arch 105 comprises an arch shaped support structure 126, and a horizontal spray bar assembly 130.

The arch shaped support structure 126 has a first and second vertical support columns 131, 132 rigidly connecting to a horizontal cross member 133. The support structure is suitably formed of steel or aluminum welded or bolted together. Sprayer arch 105 has two opposing interior vertical walls 135 facing wash zone 115. Horizontal spray bar assembly 130 spans the width of wash zone 115 and tracks up and down on inwardly facing guide surfaces 136 and a vertical slot or channel 137 in each of the vertical support columns. The horizontal connecting support and interior vertical walls 135 contain a series of spray jets 140.

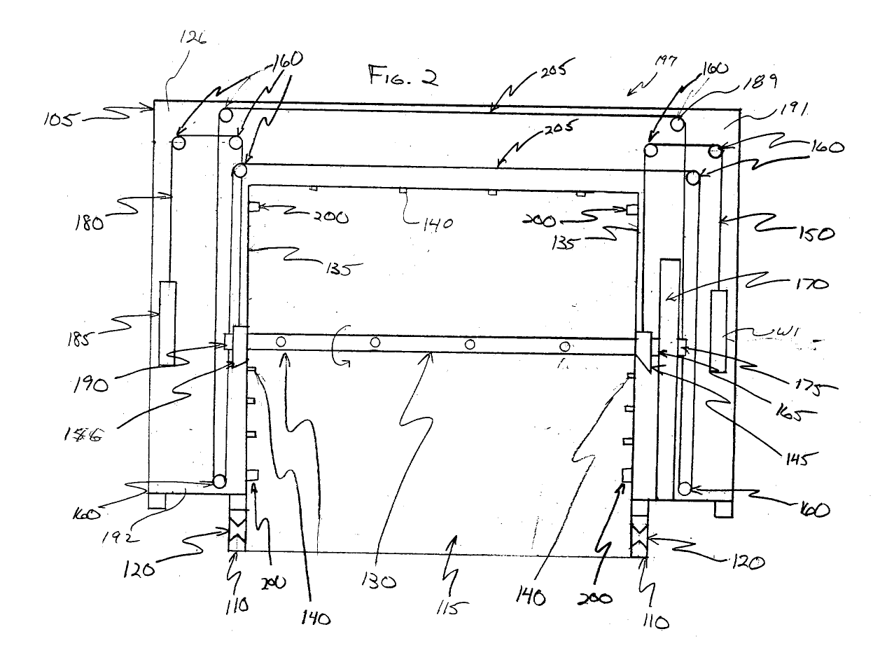

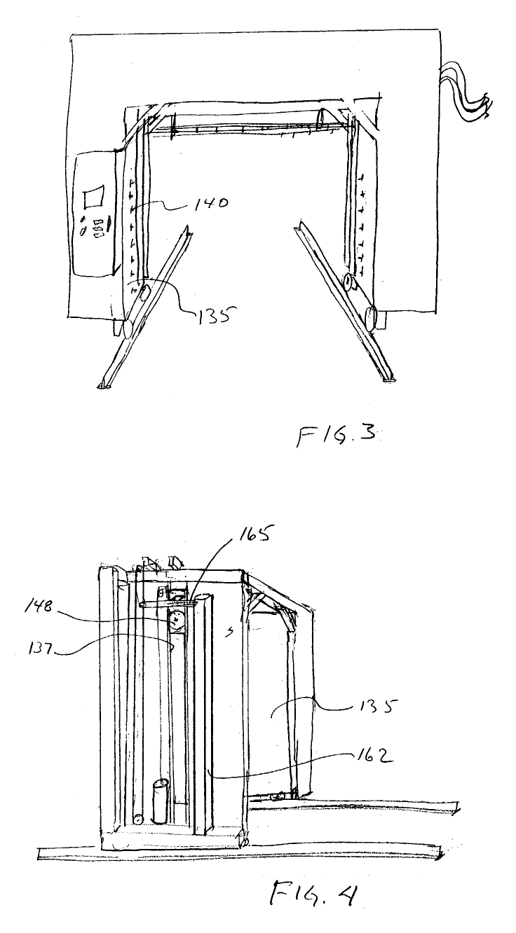

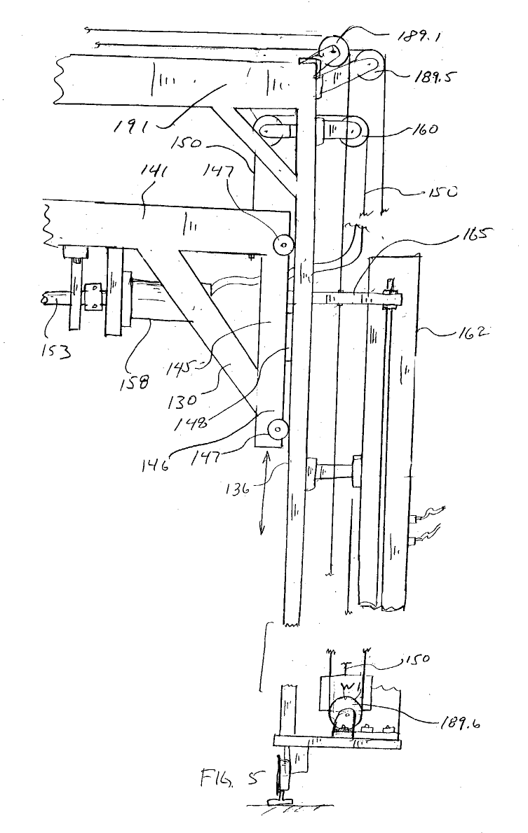

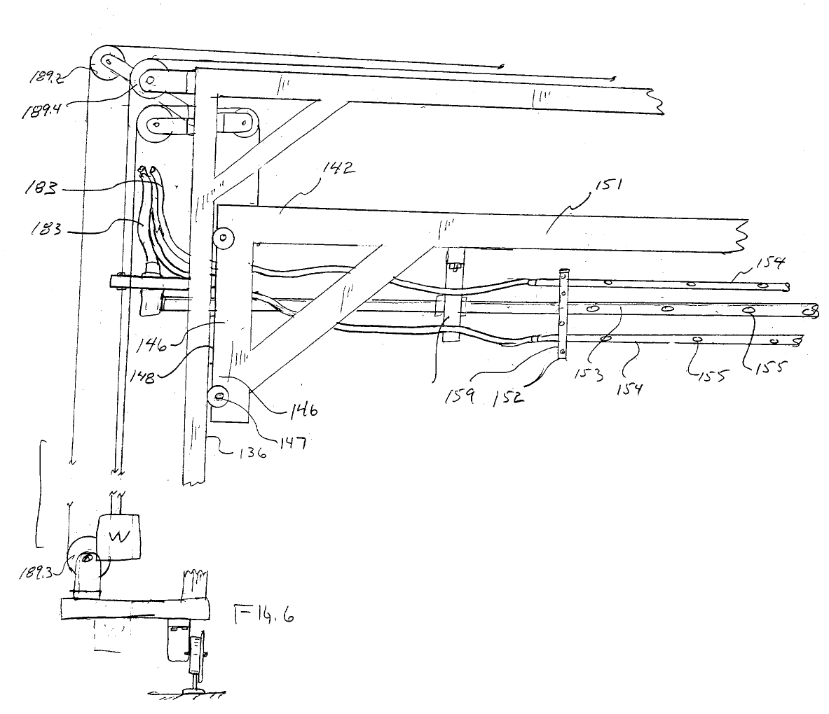

Referring to specifically FIGS. 2, 5, and 6, horizontal spray bar assembly 130 has a first end 141 and a second end 142 that are attached to the arch shaped support structure 126 by way of a first connecting member 145 and second connecting member 146, both configured as roller assemblies with engagement wheels 147 and a larger guide wheel 148. The spray bar assembly is generally configured as a carriage 149 that is engaged between the vertical support columns. The assembly 130 has a horizontal support frame 151 to which the roller assemblies 145, 146 are attached and that supports a rotatable spray bar 152. In a preferred embodiment, the rotatable spray bar 152 may be comprised of a plurality of hollow conduits which may be, for example, a high pressure water conduit 153, and a pair of low pressure detergent or other conditioning fluid conduits 154. Each conduit has a plurality of spray jets 155 thereon. The spray bar 152 is rotatably attached to the support frame 151 by way of bearing blocks 157 which may be formed of high-density polyethylene. A drive motor 158, operated electrically, pneumatically, or hydraulically, angularly positions the spray bar as is appropriate for the particular point in the washing cycle. The plurality of conduits may suitably be clamped together by metal block clamps 159.

First connecting member 145 is attached to first counterweight line 150 and extends to first counterweight W1 through a plurality of pulleys 160. First connecting member, or roller assembly, 145 is also attached to a linear drive motor 162 configured as an pneumatic cylinder through linkage 165. Air lines 166 extend to pneumatic supply (not shown). Linkage 165 is configured as a metal bracket extending through the slot 137 in the vertical wall 135 to couple with the air cylinder 162.

Second connection member 150 is attached to second counterweight W2 through counterweight line 180 through a plurality of pulleys 160. Fluid supply lines 183 may suitably be connected to the spray bar at the second end through slot 137 in the vertical wall.

The first end 141 of the spray bar assembly 130 is coupled to the second end 142 through circuit extending through a line-pulley arrangement within the arch-shaped support structure. A line comprising a cable, chain, or the like, extends preferably in a loop from a connection with the first end of the spray bar assembly upwardly to a pulley 189.1 the top 191 of the first vertical support column, then across at the horizontal cross member 133 to a pulley 189.2 at the second vertical support column, then downwardly to a pulley 189.3 at the lower region 192 of the second vertical support column, then upwardly to connect to the second end of the spray bar assembly. A line, which can be continuous with the line extending from the pulley at the lower region of the second vertical support column, then extends from the second end 142 of the spray bar assembly 130 upwardly to a pulley 189.4 also at the top region of the second vertical support column, then back across the horizontal cross member 133 to a pulley 189.5 at the top region of the first vertical support column, then downward to a pulley 189.6 at the lower region of the first vertical support column, then upwardly to connect to the first end 141 of the spray bar assembly 130. The line extending from the pulley 189.6 to the first end 141 of the spray bar assembly 130 maybe continuous with the line extending from the first end 141 to the pulley 189. 1.

The force equalization circuit 197 formed by the line-pulley arrangement effectively provides equal operating force simultaneously on the first end and the second end of the spray bar assembly 130. This eliminates binding that can occur with unequal loading. The force equalization occurs both when the bar assembly is urged upwardly and urged downwardly.

The counterweight assembly on each side of the spray arch in combination with the force equalization circuit provides a very responsive, reliable, and robust drive system for the spray bar assembly.

In operation, control system 125 sends signals to operate the air cylinder 170 as well as all fluid control devices, and the drive system of the spray arch on the track.

The present invention may be embodied in other specific forms without departing from the spirit or essential attributes thereof, and it is, therefore, desired that the present embodiment be considered in all respects as illustrative and not restrictive.

1. A vehicle washing apparatus comprising:
A track comprising a pair of parallel rails,
an arch shaped support structure having a first vertical support column, a second vertical support column, each of said support columns having a top and a bottom, an upper horizontal cross member fixed to and extending between the first and second vertical support columns, each of the vertical support columns having a vertical guide surface, the arch shaped structure supported by the track moveable back and forth on said track;
a spray bar assembly extending horizontally between the first and second vertical support columns,, engaged with the respective guide surfaces on said first and second vertical support columns, and raisable and lowerable therein, the spray bar assembly comprising a horizontal spray bar having a plurality of nozzles for spraying the vehicle, said spray bar rotatable for varying the direction of the spray, the spray bar assembly having a pair of linkage members, a first linkage member at the first vertical support column and a second linkage member at the second vertical support column; and
a drive system for raising and lowering the spray bar assembly, the drive system connecting to the linkage member at the first support column and the linkage member at the second vertical support column, the drive system driving both of said linkage members, the drive system further comprising a connecting circuit extending up each of the vertical support columns and across the horizontal cross member whereby the force for raising and lowering the spray bar assembly is applied simultaneously to the spray bar assembly at the first vertical support column and the second vertical support column.

2. The vehicle washing apparatus of claim 1, wherein the drive system comprises a linear drive motor at the first vertical support column, the drive motor connected to the first linkage member at the first vertical support column, the drive motor further connected to the second linkage member at the second vertical support column by a line extending from the first linkage member to the second linkage member.

3. The vehicle washing apparatus of claim 2, wherein the line extends upwardly from the first linkage member, horizontally at the horizontal cross member, downwardly at the second vertical support column, and then upwardly at the second vertical support column to connect to the second linkage member.

4. The vehicle washing apparatus of claim 3, wherein the line further extends upwardly from the second linkage member, horizontally at the horizontal cross member, downwardly at the first vertical support column, and then upwardly at the first horizontal support column and connecting to the first linkage member.

5. The vehicle washing apparatus of claim 2, wherein the drive motor is a linear pneumatic motor mounted at the first vertical support column.

6. The vehicle washing apparatus of claim 1, wherein a first counterweight is attached to the spray bar assembly at the first vertical support column and a second counterweight is attached to the spray bar assembly at the second vertical support column.

7. The vehicle washing apparatus of claim 4, wherein a first counterweight is attached to the spray bar assembly at the first vertical support column and a second counterweight is attached to the spray bar assembly at the second vertical support column.

8. A vehicle washing apparatus comprising:
A arch shaped support frame moveable forwardly and rearwardly with respect to the lengthwise direction of a vehicle to be washed, the arch shaped support frame having a first vertical support column and a second vertical support column;
A horizontal spray bar assembly moveable upwardly and downwardly within the arch shaped support frame, the spray bar assembly having two ends, a first end engaged with the first vertical support column and a second end engaged with the second vertical support column, a linear drive motor mounted at a first vertical support column and connecting to the first end of the spray bar assembly, a cable circuit connecting to the first end of the spray bar assembly extending up the first vertical support column over to the second column to connect to the second end of the spray bar assembly, whereby when the linear drive motor drives the first end of the spray bar assembly downwardly, the second end of the spray bar assembly is pulled downwardly by the cable circuit.

9. The vehicle washing system of claim 8 wherein the cable circuit extends upwardly and downwardly from the first end of the spray bar assembly and also the second end of the spray bar assembly whereby when the linear drive motor drives the first end of the spray bar assembly upwardly, the second end of the spray bar assembly is pulled upwardly.

10. The vehicle washing system of claim 8 wherein the horizontal spray bar assembly has a counterweight attached thereto providing an upward force to the spray bar.

11. The vehicle washing system of claim 9 wherein the horizontal spray bar assembly has a first counterweight attached at the first end and a second counterweight attached to the second end.

12. A method of washing a vehicle in a vehicle washing apparatus having a horizontal spray bar assembly with a first end and a second end, extending between a pair of vertical guides and moveable upwardly and downwardly therebetween, the method comprising the steps of:
driving the first end of the horizontal spray bar by a linear drive upwardly and simultaneously pulling the second end of the horizontal spray bar upwardly by a cable circuit;
driving the first end of the horizontal spray bar by the linear drive downwardly and simultaneously pulling the second end of the horizontal spray bar downwardly by the cable circuit; and
spraying fluid from the horizontal spray bar assembly onto the vehicle as it is moving upwardly and downwardly.

13. The method of claim 12 further comprising the step of unweighting the horizontal spray bar assembly by a counterweight attached thereto.

14. The method of claim 13 further comprising the step of unweighting the horizontal spray bar assembly by separate counterweights at the first end and at the second end of the spray bar assembly.

15. The method of claim 12 further comprising the step of partially rotating a spray bar of the spray bar assembly as fluid is being sprayed onto the vehicle.

16. The method of claim 15 further comprising the step of moving the spray bar assembly along the length of the vehicle being washed.
